(19) United States
(12) Patent Application Publication
(10) Pub. No.: US 2015/0189543 A1
(43) Pub. Date: Jul. 2, 2015

(54) System and Methods for Providing an Enhanced Content Proxy in a Wireless Network

(71) Applicant: International Datacasting Corporation, Kanata (CA)

(72) Inventors: Bastian STASSEN, Ottawa (CA); Gary CARTER, Kanata (CA); David John Smith, Georgetown (CA); Gregory Paul Burdett, Mississauga (CA)

(73) Assignee: International Datacasting Corporation, Kanata (CA)

(21) Appl. No.: 14/171,012

(22) Filed: Feb. 3, 2014

Related U.S. Application Data
(60) Provisional application No. 61/920,790, filed on Dec. 26, 2013.

(51) Int. Cl. H04W 28/02

(52) U.S. Cl. CPC H04W 28/0289

(57) ABSTRACT

A method comprising: receiving, by wireless sites connected to a terrestrial network, a set of media that includes a plurality of individual media, wherein each of the wireless sites includes a satellite antenna and satellite receiver via which the set of media is received from a broadcast transmission from a satellite; storing the set of media, wherein each of the wireless sites stores the set of media in a local edge proxy server of the wireless site; receiving request(s) for media from mobile station(s); accessing the requested media from the set of media stored in the local edge proxy server; receiving requests for retransmission of said media from said mobile station(s); determining if a first of said retransmission requests is identical to a prior retransmission request; and if said first retransmission request is identical to said prior retransmission request, determining whether said prior retransmission request has been fulfilled.

### FIELD OF THE INVENTION

The present disclosure relates to wireless networks and content delivery in wireless networks.

### BACKGROUND OF THE INVENTION

Mobile stations, such as mobile telephones, smart phones, laptop computers, tablet computers and the like are increasingly being utilized to access large files and high bit rate streaming multimedia content such as computer files, video and audio. This content requires much more data than a traditional telephone voice call. Although the ability to handle this increased capacity demand continues to be met at the air interface side of the network (i.e., between a wireless site and a mobile station), the networks for delivering this information to the wireless sites will likely not be able to achieve the required capacity to meet these demands without substantial, and possibly cost-prohibitive, capital outlays.

FIG. 1 is a block diagram of a conventional wireless system. In order to provide content to mobile stations, a plurality of content providers (CPs) 101A-101G provides media content to one or more content aggregators (CAGs) 103A, 103B. One or more mobile stations are able to send one or more requests for particular content to one or more wireless nodes. For example, when mobile station 111 transmits a request for particular content, the request is sent to, for example, wireless site antenna 110A of wireless node 112A. The request is then passed through network gateway (NGW) 115, terrestrial network 112 (e.g., a backhaul network) until it reaches the appropriate content aggregator that stores the requested content. The requested content is then retrieved and provided along the reverse path through the terrestrial network 112, network gateway 115, wireless node 112a and wireless antenna 110a until the content reaches mobile station 111.

As illustrated in FIG. 1, more than one wireless site will be coupled to CAGs 103a, 103b through terrestrial network 112. In practice, hundreds of thousands of wireless sites may be connected in this manner. Each wireless site can support a number of users, and accordingly at any given time there could be hundreds of thousands of streams of content passing through the terrestrial network. This is particularly problematic because terrestrial networks supporting wireless sites were originally dimensioned to support low-bit rate voice traffic. Increasing these terrestrial networks to accommodate the high capacity requirements to support the content requests of a large number of mobile stations may be prohibitively expensive.

Conventional techniques to minimize the network capacity issues involved user request driven storage strategies, such as caching and predictive caching of data at the wireless nodes. Such techniques analyzed user requests to determine the data that should be cached. These methods are not capable of significantly reducing the network load in order to resolve the problems created by the demand for large files and high speed media distribution. Additionally, because these techniques cache data based on user requests, the first time a particular user requests data it would have to be obtained through the terrestrial network, thus incurring a delay before the data could be provided to the user.

A system and method utilizing edge proxy servers to resolve some of the problems outlined above was described in detail in US Patent Application 2012/0258708 by Carter et al, filed on Apr. 5, 2012, published on Oct. 11, 2012 and herein incorporated by reference as if reproduced in its entirety. However the edge proxy servers in the system and method of US Patent Application 2012/0258708 were not capable of integration into a Long Term Evolution (LTE) architecture. The system and method of US Patent Application 2012/0258708 also did not have the capabilities to deal with the problem of flooding the system with identical requests for missing or erroneous packets in a media stream.

### SUMMARY OF THE INVENTION

A method comprising: receiving, by a plurality of wireless sites connected to a terrestrial network, a same substantially similar set of media that includes a plurality of individual media independent of a local user request for any of the plurality of individual media in the set of media, wherein each of the wireless sites includes a satellite antenna and satellite receiver via which the set of media is received from a broadcast transmission from a satellite; storing, by each of the wireless sites, the set of media, wherein each of the wireless sites stores the set of media in a local edge proxy server of the wireless site; receiving, by one of the plurality of the wireless sites, one or more requests for media from one or more mobile stations; accessing, by the one of the plurality of wireless sites, the requested media from the set of media stored in the local edge proxy server; receiving, by one of the plurality of the wireless sites, one or more requests for retransmission of said media from said one or more mobile stations; determining, by one of the plurality of the wireless sites, if a first of said one or more retransmission requests is identical to a prior retransmission request; and if said first retransmission request is identical to said prior retransmission request, determining whether said prior retransmission request has been fulfilled.

An apparatus comprising: a satellite antenna; a satellite receiver coupled to the satellite antenna; and an enhanced edge proxy server coupled to the satellite receiver and to a wireless node, wherein the enhanced edge proxy server includes a processor and memory, the memory storing a set of media, which includes a plurality of individual media, received via the satellite antenna and the satellite receiver, wherein the enhanced edge proxy server stores the set of media independent of a local user request for any of the plurality of individual media in the set of media provides a live media stream from the set of media to a mobile station, said providing performed using Evolved Multimedia Broadcast Multicast Service Long-Term Evolution (eMBMS LTE), wherein the enhanced edge proxy server is located at a wireless site of the wireless node.

A system to provide one or more sets of media to a plurality of mobile stations, said system comprising a plurality of wireless sites connected to a terrestrial network; each of said plurality of wireless sites including a satellite antenna and a satellite receiver via which the one or more sets of media is received from a broadcast transmission from a satellite, each of said plurality of wireless sites serving a corresponding area and comprising an enhanced edge proxy server with an associated storage capacity, wherein each of said plurality of wireless sites stores the one or more sets of media in the corresponding enhanced edge proxy server, wherein each associated storage capacity depends on at least one of a size of the area, and a projected demand served by the corresponding wireless site; and further wherein said system comprises a first wireless site, said first wireless site comprising a first enhanced edge proxy server, and said first enhanced edge proxy server storing one or more of the one or more sets of media.

### BRIEF DESCRIPTION OF THE DRAWINGS

Exemplary embodiments of the invention will now be described in conjunction with the following drawings, in which:

FIG. 1 illustrates a block diagram of a conventional wireless system;

FIG. 2 illustrates a block diagram illustrating an exemplary system in accordance with the present invention;

FIG. 2B illustrates an enhanced edge proxy server for Long Term Evolution (LTE) emulation;

FIG. 3 is a flow chart illustrating an exemplary method in accordance with the present invention; and

FIG. 4 is a flow chart illustrating an exemplary method in accordance with the present invention.

FIGS. 5A and 5B are flow charts for requesting retransmission of missed or erroneous media packets.

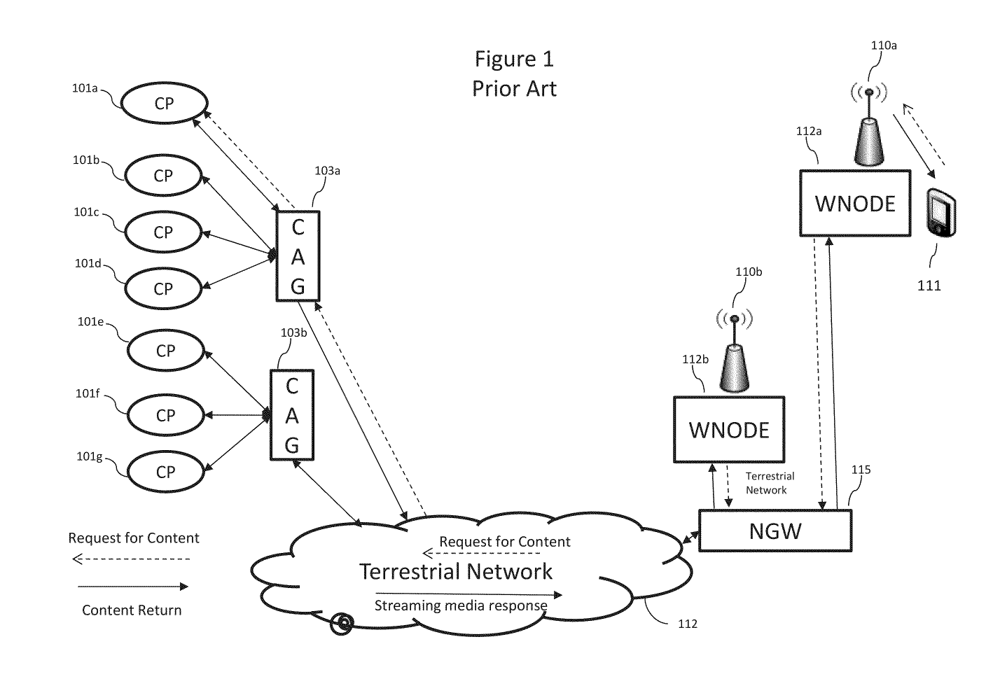

### DETAILED DESCRIPTION OF THE INVENTION

While the present disclosure is susceptible to various modifications and alternative forms, specific embodiments or implementations have been shown by way of example in the drawings and will be described in detail herein. It should be understood, however, that the disclosure is not intended to be limited to the particular forms disclosed. Rather, the disclosure is to cover all modifications, equivalents, and alternatives falling within the spirit and scope of an invention as defined by the appended claims.

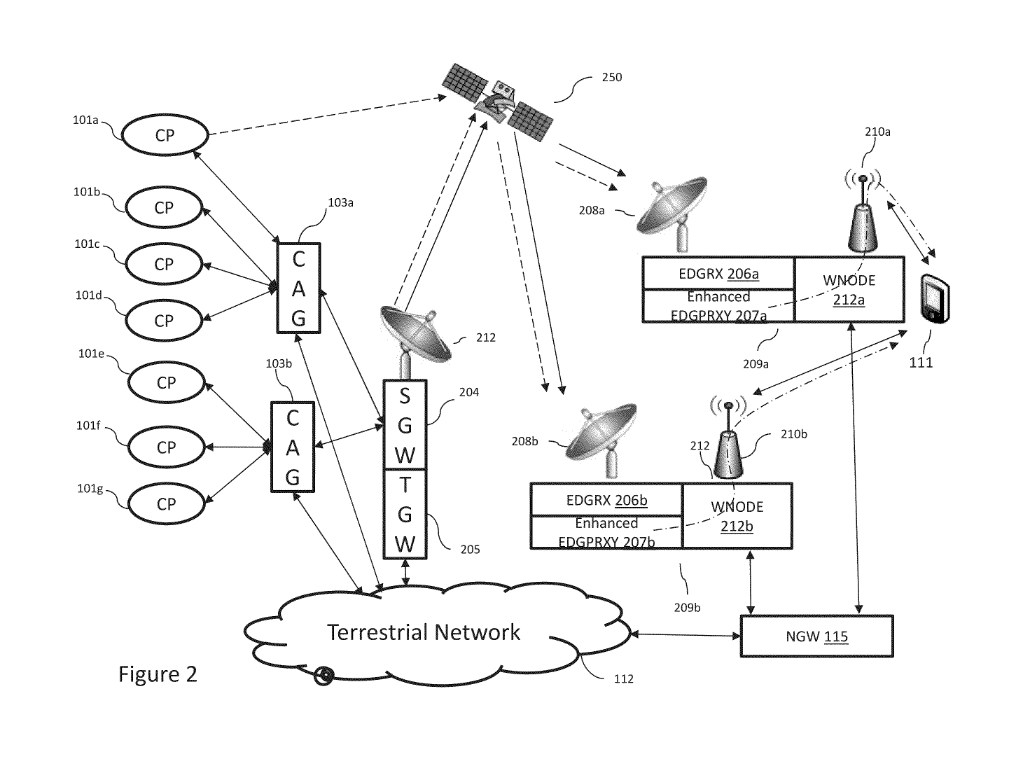

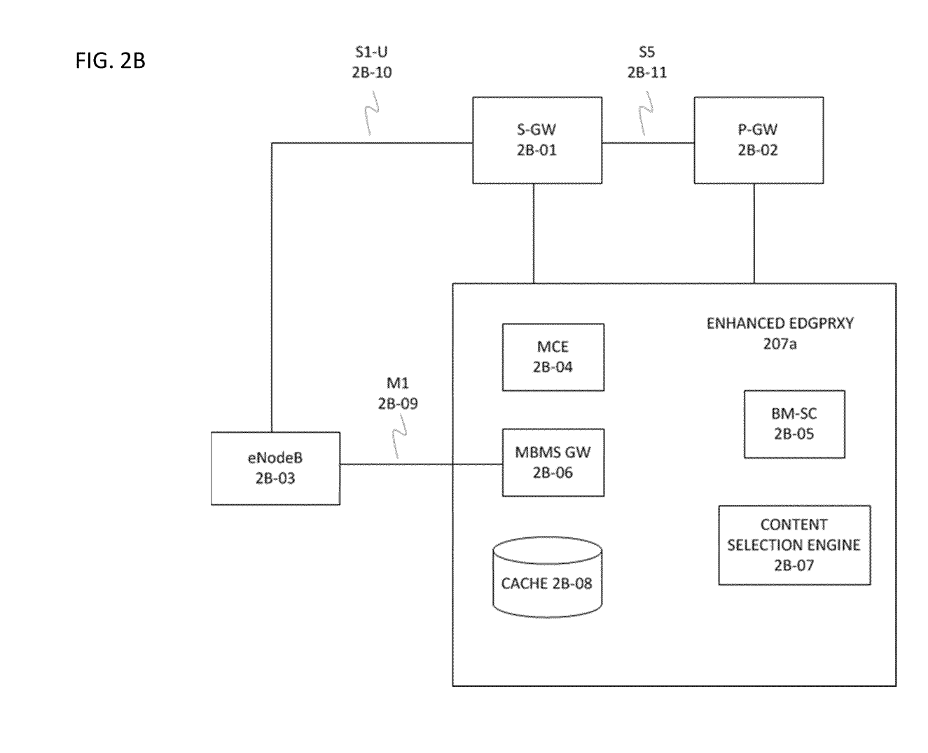

FIG. 2 is a block diagram of an exemplary system in accordance with the present invention. As illustrated in FIG. 2, enhanced edge proxy servers 207a and 207b are added to wireless sites 209a and 209b respectively. The enhanced edge proxy servers 207a and 207b can be considered as a local proxy server at wireless sites 209a and 209b. Accordingly, in the rest of this description the terms enhanced edge proxy server, enhanced local proxy server and enhanced local edge proxy server will be used interchangeably. Wireless sites 209a and 209b additionally comprise edge satellite antennas such as edge satellite antenna 208a and 208b, multi-channel edge proxy receivers such as 206a and 206b, wireless nodes such as 212a and 212b, and wireless antennas such as 210a and 210b. The wireless sites 209a and 209b can employ any type of communication protocol, including, but not limited to, WiMAX, EDGE, GPRS, Long Term Evolution (LTE), 1×RTT, any of the 802.11 protocols. Additionally, in one embodiment, mobile station 111 is connected to wireless sites 209a and 209b or other such wireless sites via one or more radio access networks (RANs). Wireless sites 209a and 209b can be any type of wireless site, such as, for example, a wireless router or switch providing a wireless local area network, a wireless base station providing a wireless wide area network (e.g., a conventional wireless cell), or an Evolved Node B (eNodeB) in an LTE network.

As will be described in more detail below, the edge receivers 206a and 206b receive file-based media content via satellite transmissions and store a large volume of the file-based media content in the enhanced edge proxy server 207a, 207b so that content requests are served directly from the local wireless sites instead of traversing terrestrial network 112 for each request. The file-based media content is stored independent of a local user request, such as, for example, a request from a mobile station supported by the wireless site, for media in the set of media. This is achieved by providing a satellite gateway 204 coupled to each content aggregator 103a and 103b and to satellite 250. Thus, media content is eliminated from the terrestrial network, which frees-up capacity for voice calls and eliminates the need for significant increases in the capacity of the terrestrial network infrastructure. The terrestrial network can be any type of network, including a private network and/or the internet. Additionally, although not illustrated, the terrestrial network couples wireless nodes 212a and 212b to a wireless network operator's core network to support voice and/or data communication in a conventional manner.

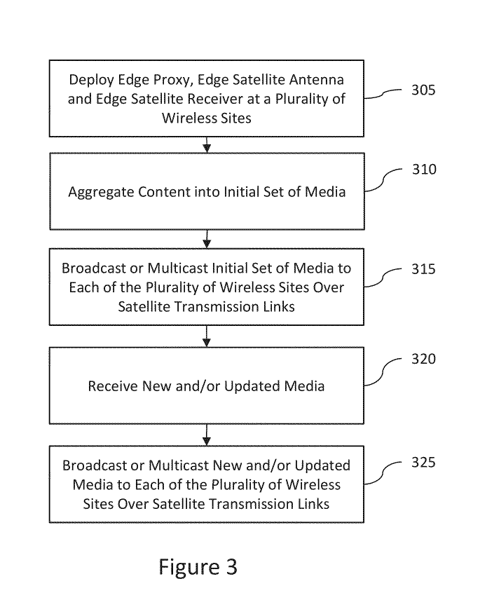

The operation of the system of FIG. 2 will now be described in connection with the flow charts of FIGS. 3, 4, 5A and 5B. Initially, an enhanced edge proxy server such as enhanced edge proxy server 207a or 207b, an edge satellite antenna such as edge satellite antenna 208a or 208b, and a multi-channel edge proxy receiver such as 206a or 206b are deployed at each of a plurality of wireless sites such as 209a or 209b (step 305). After deployment, content aggregators such as 103a or 103b aggregate media from one or more content providers 101a-101g to form an initial, secure set of media (step 310). The media can be individually secured and/or secured as a package using any technique, including encryption and/or any type of digital rights management. The content aggregators 103a and 103b provide the initial, secure set of aggregated media to satellite gateway 204, which then transmits the content to one or more satellites 250 via satellite antenna 212. The one or more satellites 250 securely broadcast or multicast the initial set of content (step 315), which is received by wireless site satellite antennas 208a and 208b, passed to edge proxy receivers 206a and 206b respectively, and then provided to enhanced edge proxy servers 207a and 207b respectively where the content is locally stored at the wireless sites 209a and 209b.

In another embodiment, one or more of the wireless sites 209a and 209b are part of an Evolved Multimedia Broadcast Multicast Service (eMBMS) LTE architecture. An eMBMS LTE architecture is described in, for example, “LTE eMBMS Technology Overview” released November 2012 by Qualcomm Research, herein incorporated by reference as if reproduced in its entirety. In one embodiment, the enhanced edge proxy server emulates components in a typical eMBMS system, such as shown in page 8 of the “LTE eMBMS Technology Overview” document. For example, the enhanced edge proxy server incorporates the functionalities of one or more of the eMBMS Gateway (MBMS GW), Broadcast Multicast Service Center (BM-SC), Serving Gateway (S-GW), Packet Data Network Gateway (P-GW), andMulti-cell/multicast Coordination Entity (MCE).

An example embodiment of an architecture of an enhanced edge proxy server 207a designed for LTE emulation is shown in FIG. 2B and described further below. This is but one embodiment of an enhanced edge proxy server for LTE emulation. Other embodiments are also possible.

In this embodiment, the enhanced edge proxy server comprises the MBMS GW 2B-06, the BM-SC 2B-05, an MCE 2B-04, a cache 2B-08 and a content selection engine 2B-07. In one embodiment, one or more of an eNodeB 2B-03, P-GW 2B-01 and S-GW 2B-02 also reside on a wireless site such as site 209a or 209b. The eNodeB 2B-03 is connected to S-GW 2B-01 via S1-U interface 2B-10. The S-GW 2B-01 is connected to P-GW via S5 interface 2B-11. The S1-U interface 2B-10, MCE 2B-04 and S5 interface 2B-11 are known to those of skill in the art.

In one embodiment, the enhanced edge proxy server 207a is also connected to S-GW 2B-01 and P-GW 2B-02. In a further embodiment, similar to that shown in page 8 of the “LTE eMBMS Technology Overview” document, the MBMS GW 2B-06 is connected to the BM-SC 2B-05, so as to receive content and media from the BM-SC 2B- 05 via, for example, an SGi-mb interface, the details of which are known to those of skill in the art. In other embodiments, while the details have not been provided here, it would be known to those of skill in the art that the various components within the enhanced edge proxy server 207a can be interconnected using other interfaces and connection techniques.

The cache 2B-08 is used to store media which is to be distributed to the one or more mobile stations connected to the wireless site. This media is received from, for example, the broadcast transmissions received via the satellite antenna and the edge proxy receiver connected to the enhanced edge proxy server, such as satellite antenna 208a and edge proxy receiver 206a connected to enhanced edge proxy server 207a.

The content selection engine 2B-07 manages and processes user requests from the mobile stations connected to the wireless site for one or more sets of media stored in cache 2B-08. In one embodiment, it also determines which media is to be stored at cache 2B-08. In another embodiment, it interfaces with BM-SC 2B-05 so as to distribute content and media towards the mobile stations.

When performing LTE emulation, in one embodiment the MBMS GW 2B-06 would connect with eNodeB 2B-03 through, for example, the M1 interface 2B-09 defined for eMBMS on an LTE network. The M1 interface is well known to those of skill in the art. One example embodiment is shown in FIG. 2B but other embodiments are envisioned. In another embodiment, the M1 interface 2B-09 transits from the eNodeB 2B-03 to the P-GW 2B-02. In yet another embodiment, the M1 interface 2B-09 transits from the eNodeB 2B-03 to the P-GW 2B-02 via the S-GW 2B-01. In yet another embodiment, the M1 interface 2B-09 transits from the eNodeB 2B-03 to the BM-SC 2B- 05. In another embodiment, the enhanced edge proxy server interfaces with M1 anywhere along the path.

In one embodiment, as explained in the “LTE eMBMS Technology Overview” document, the MBMS GW 2B-06 performs functionalities which includes
relaying session control messages towards Mobility Management Entities (MMES) involved in an eMBMS session,
distributing content and media stored in cache 2B-08 towards eNodeB 2B-03 in an eMBMS session via M1 interface 2B-09.

In one embodiment, as explained in the “LTE eMBMS Technology Overview” document, the BM-SC 2B-05 performs the following functionalities:
membership,
session and transmission of media and content towards MBMS GW 2B-06 as previously explained,
proxy and transport,
service announcement,
security, and
content synchronization.

In a further embodiment, the BM-SC 2B-05 and MBMS GW 2B-06 perform additional functionalities which include, but are not limited to;
create and maintain M1 GPRS Tunneling Protocol-U (GTP-U) tunnel,
encapsulate Internet Protocol (IP) traffic into GTP-U,
bearer content processing including Forward Error Correction (FEC), File Delivery over Unidirectional Transport (FLUTE) and SYNC, and
using IP Source Specific Multicast (SSM) as the source of traffic on M1 interface 2B-09.

In such an integrated architecture, when a request for a video stream which is stored at the enhanced edge proxy server arrives from a mobile station such as mobile station 111, then the enhanced edge proxy server 207a will emulate the protocols that the mobile station would expect to receive from an LTE mobile network to provide the video stream over eMBMS. In the embodiment where the mobile station 111 is connected to mobile station 111 is connected to the wireless sites via one or more radio access networks (RANs), this approach can reduce congestion in the one or more RANs in addition to the terrestrial network by leveraging the capabilities of eMBMS. The emulation capabilities of the enhanced edge proxy server represent an improvement over systems described in US Patent Application 2012/0258708 by Carter et al.

While the emulation techniques above are described with reference to the current version of eMBMS LTE, these emulation techniques are not limited to the current version of eMBMS LTE and can also be applied to other variants of eMBMS LTE, including future versions of eMBMS LTE.

New or updated media can be provided either directly from a content provider 101a-101g to satellite 250 or via satellite gateway 204 and the new or updated content is then broadcast or multicast to each of the plurality of wireless sites via satellite transmission links in a similar manner to that described above (steps 320 and 325). New or updated media may be provided directly from a content provider 101a-101g using existing satellite services or channels, which may be performed for live streaming of content, such as live events, live television programs, live audio programs. Using the method of FIG. 3, each of a plurality of wireless sites within a particular geographic area will include a substantially similar set of media. This media can be any type of media, including, but not limited to, video and audio. The set of media can be, for example, the entire set of media for Apple, Inc.'s iTunes®, a television network. In the case of Apple, Inc.'s iTunes® the set of media can include a plurality of individual media, such as songs, videos (e.g., music videos, television shows, and movies), applications (“apps”), books, and the like. In the case of a television network the set of media can include a plurality of individual media, such as television programs, movies and related content. Moreover, the entire set of media can be media from a number of content providers, such as a number of television networks, movie studios and/or content providers such as Apple, Inc.'s iTunes®.

The enhanced edge proxy servers may have varying storage and serving capacities depending on, for example, the wireless site it is attached to. In turn, the size of the wireless node may depend on factors such as the geographical area each wireless node is serving, or the projected demand to be serviced by the wireless node. For example, in one embodiment, the wireless site is designed to serve an LTE picocell. Further information on such wireless sites to serve LTE picocells can be found in, for example, “LTE; Evolved Universal Terrestrial Radio Access (E-UTRA); Radio Frequency (RF) requirements for LTE Pico Node B (3GPP TR 36.931 version 9.0.0 Release 9)”, released May 2011 and herein incorporated by reference as if disclosed in its entirety. Then, an enhanced edge proxy server which is part of a wireless site to serve a picocell, may have a smaller storage capacity designed to hold media streams which would be accessed by users of such a picocell when compared to a wireless site for a microcell or a macrocell. Since the storage capacity is smaller, there is a need to carefully select the media which is to be stored. In one embodiment, the enhanced edge proxy server selects the media to be stored depending on, for example, the location of the picocell, the context surrounding the picocell, or the nature of the users. For example, a picocell in a stadium or sporting arena holds media streams comprising apps on specific teams; files containing statistics; and videos of action replays so that users can readily access these apps or files or replays. This represents a further improvement over the systems described in US Patent Application 2012/0258708 by Carter et al. Similarly, in another embodiment the wireless site is designed to serve an LTE femtocell. Further information on such wireless sites to serve LTE femtocells can be found in, for example,
“HeNB (LTE Femto) Network Architecture”, by the Femto Forum, released May 2011, and
“3rd Generation Partnership Project; Technical Specification Group Services and System Aspects; Architecture aspects of Home NodeB and Home eNodeB (Release 9)
   both of which herein incorporated by reference as if reproduced in its entirety. Then similar to the discussion above for picocells, since the storage capacity for such an enhanced edge proxy server is likely to be smaller when compared to a picocell, microcell or a macrocell, there is a greater need to carefully select the media to be stored. Similar to as discussed above, the selection of media to be stored depends on one or more of the location of the femtocell, the context of the femtocell or the nature of the users of the femtocell.

The transmission from content providers 101a-101g and/or content aggregators 103a, 103b to satellite 250 and the transmissions from satellite 250 to wireless sites 209a, 209b can employ File Broadcast Protocol (FBP) to detect errors in file transmissions. In another embodiment, wireless sites 209a and 209b request retransmission of missed/erroneous packets from the terrestrial gateway (TGW) 205 via terrestrial network 112 using network gateway (NGW) 115. In one embodiment, the retransmission requesting is performed using Backhaul Messaging Protocol (BMP).

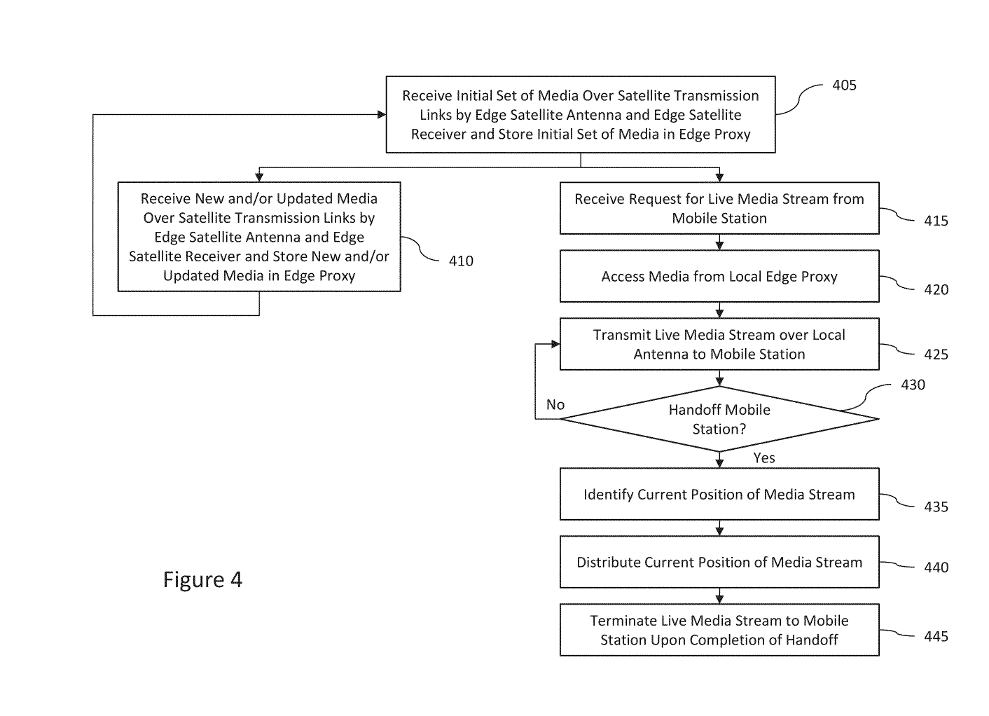

FIG. 4 is a flow chart of a method for a wireless site 209a, 209b in accordance with exemplary embodiments of the present invention. Initially, a wireless site 209a, 209b receives an initial set of media over satellite transmission links from one or more satellites 250 (step 405). Specifically, the initial set of media is received by satellite antenna 208a, 208b, passed to edge proxy receiver 206a, 206b, and then stored in enhanced edge proxy server 207a, 207b. New and/or updated media can be received from one or more satellites 250 and stored in the same manner as discussed above (step 410). Again, the set of media, new media and updated media is received independent of a local request from a mobile station supported by the wireless site.

When wireless site 209a, 209b receives a request for a live media stream from a mobile station 111 (step 415), wireless node 212a, 212b accesses the stored content from the local storage of enhanced edge proxy server 207a, 207b (step 420) and then transmits the live media stream over local antenna 210a to the mobile station 111 (step 425). If necessary, enhanced edge proxy server 207a, 207b can transcode, transrate and/or convert the format of the media to accommodate a media player in the mobile station. This can be performed using, for example, information in the request for the media stream received from the mobile station.

It will be recognized that wireless sites 209a, 209b have a limited transmission range, and accordingly if mobile station 111 moves towards the outer reaches of the transmission range it will be necessary to handoff the mobile station to another wireless site. Thus, for example, mobile station 111 may initially receive a live media stream from wireless site 209a and when it moves towards wireless site 209b the mobile station will be handed-off to wireless site 209b. Accordingly, wireless site 209a will continue to transmit the live media stream to mobile station 111 (step 425) as long as a hand-off is not required (“No” path out of decision step 430). When, however, hand-off is required (“Yes” path out of decision step 430), then wireless site 209a determines the current position of the media stream (step 435), distributes the current position (step 440) and terminates transmission of the live media stream upon completion of the handoff (step 445). The wireless site can inform the content provider and/or content aggregator of the use of the content when the content is initially transmitted to the mobile station and/or upon termination of the transmission so that the user of the mobile station can be charged for accessing the content. This can be achieved using Backhaul Messaging Protocol (BMP) to communicate with content providers 101a-101g using proxy messaging, file reception and playout confirmation messages as required for proof of delivery and billing applications.

The method illustrated in FIG. 4 can be performed using instructions stored on a non-transitory computer-readable medium. Thus, for example, the enhanced edge proxy server can include a processor that executes the instructions stored on the non-transitory computer-readable medium to perform some or all of the steps in FIG. 4. Alternatively, the enhanced edge proxy server can include an application specific integrated circuit (ASIC) and/or a field programmable gate array (FPGA) to perform some or all of the steps in FIG. 4.

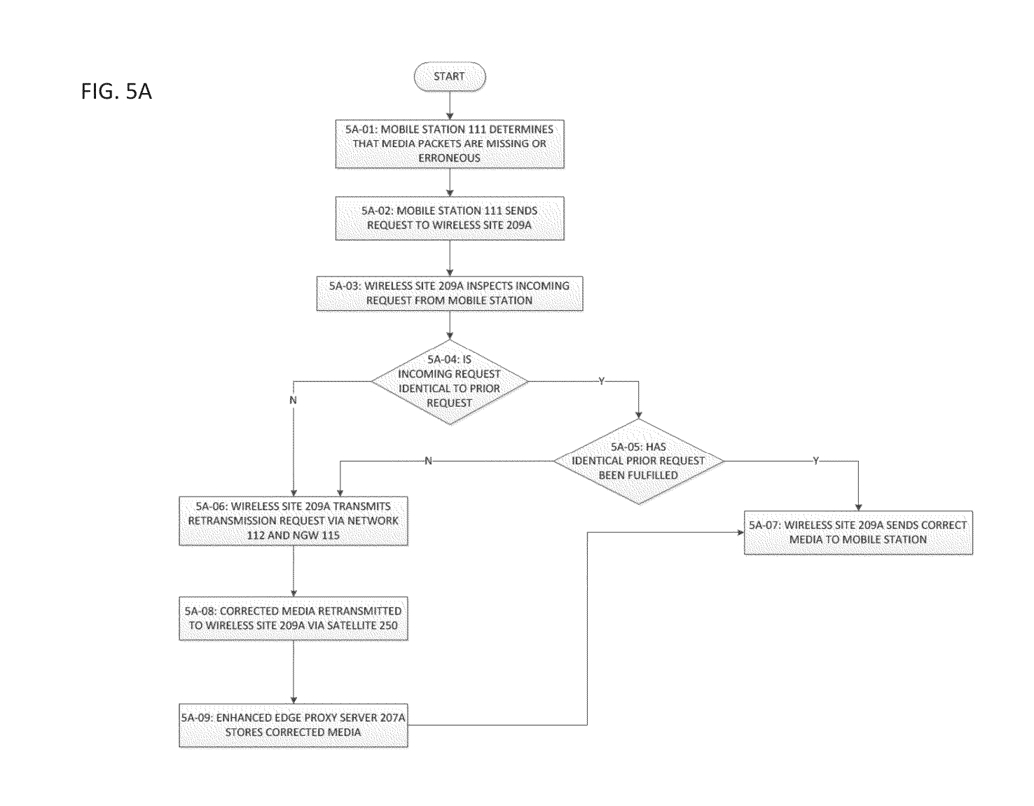

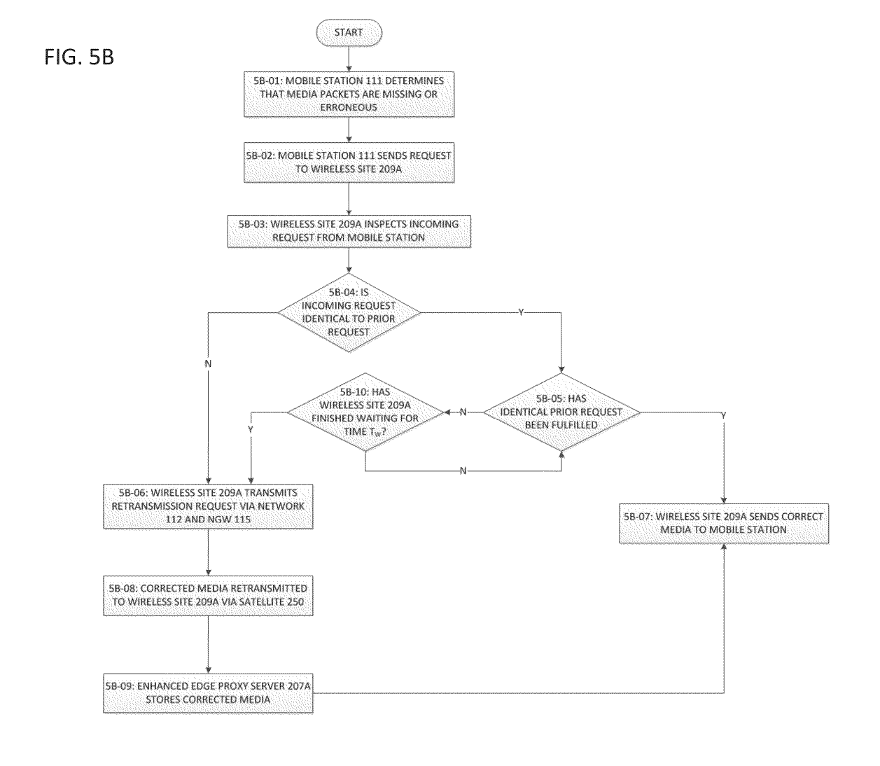

As explained previously, wireless sites 209a and 209b request retransmission of missed/erroneous packets from the terrestrial gateway (TGW) 205 via terrestrial network 112 using network gateway (NGW) 115. If one or more mobile stations access the same media stream in which there are one or more missing/erroneous packets, it is then likely that the one or more mobile stations will send identical requests for the one or more missing/erroneous packets. If each identical request is retransmitted then NGW 115, terrestrial network 112 and TGW 205 will be flooded with identical requests, thus increasing processing delay and the load on terrestrial network 112. FIG. 5A demonstrates an embodiment to reduce the flooding problem. In step 5A-01 one of the one or more mobile stations, for example, mobile station 111 determines that one or more packets are missing or erroneous. Mobile station 111 sends a request to wireless site 209a (5A-02). In 5A-03 wireless site 209a inspects each incoming request. In 5A-04, wireless site 209a determines whether the incoming request is identical to a prior request for missing/erroneous packets, or is a new request. If the incoming request is a new request, then wireless site 209a transmits a retransmission request corresponding to the incoming request using for example, BMP via terrestrial network 112 through NGW 115 (5A-06). The corrected media is then retransmitted to wireless site 209a via satellite 250 (5A-08). The enhanced edge proxy server 207a stores the corrected media (5A-09). The wireless site 209a transmits the corrected media to mobile station 111 (5A-07). However, if the incoming request is identical to a prior request, the enhanced edge proxy server determines if the identical prior request has been fulfilled (5A-05). If not, then steps 5A-06, 5A-08 and 5A-09 are performed. If the identical prior request has been fulfilled, then the wireless site 209a transmits the corrected media to mobile station 111 (5A-07). This way, NGW 115, terrestrial network 112 and TGW 205 are not flooded with duplicate requests, thus reducing processing delay and conserving bandwidth.

In an alternate embodiment illustrated in FIG. 5B, the steps 5B-01 to 5B-09 are identical to steps 5A-01 to 5A-09, and the following additional step 5B-10 is added: If the incoming request is identical to a prior request, and the identical prior request is unfulfilled, the wireless site waits for time T_{w}. If during time T_{w} the identical prior request is not fulfilled, then steps 5B-06, 5B-08 and 5B-09 are performed. In one embodiment, T_{w} is fixed, and set depending on the average time taken between sending a request and the corrected media to be received by the enhanced edge proxy server. In another embodiment, T_{w} varies depending on, for example, average time taken between sending a request and the corrected media to be received by the enhanced edge proxy server for the last N requests. In yet another embodiment, T_{w} is randomly distributed and drawn from a probability density function (PDF). The PDF could be, for example, an exponential PDF or a uniform PDF. The parameters of such a PDF are set depending on, for example, historical records of time taken between sending a request and the corrected media to be received by the enhanced edge proxy server. By waiting to see whether the identical prior request has been fulfilled before sending on a request, NGW 115, terrestrial network 112 and TGW 205 are less likely to be flooded with similar requests, thus reducing processing delay and conserving bandwidth.

The capabilities of removing duplication of requests for missing/erroneous packets and waiting before sending on new requests for missing/erroneous packets represent a further improvement over the system and method described in US Patent Application 2012/0258708 by Carter et al.

Exemplary embodiments of the present invention are not limited in the manner in which handoff occurs. Thus, for example, the present invention can employ mobile station-initiated handoff, base station-initiated handoff, infrastructure-initiated handoff or any combination of thereof. Accordingly, the handoff determination can be based on receipt of a handoff indication from the mobile station, another wireless site and/or the wireless network infrastructure. Additionally, the handoff can be a hard handoff (i.e., a break-before-make handoff) in which the mobile station only receives a media stream from one wireless site at a time, a soft handoff (i.e., a make-before-break handoff) in which the mobile station will receive the media stream from more than one wireless site during the handoff process or any variation of these types of handoffs. File downloads can be provided using a point-to-point unicast connection with the mobile station, whereas live streams can be provided using a point-to-point with the mobile station or a point-to-multipoint connection with mobile stations capable of implementing an IGMP join to a multicast group on multicast capable router.

Exemplary embodiments of the present invention are also not limited in the manner in which the current position of the media stream is identified and distributed. The current position can be identified based on packet sequence numbers/indicators. Additionally, the current position can be distributed directly to the wireless site to which the mobile station is handing-over via the air interface, can be distributed first to the mobile station which then transmits it to the wireless site to which the mobile station is handing-over and/or can be distributed via the wireless network infrastructure to the wireless site to which the mobile station is handing-over.

By employing the broadcasting and/or multicasting of the media from the satellite in combination with local storage in a proxy server of the media at the wireless sites, exemplary embodiments of the present invention reduce costs and improve customer performance on mobile networks compared to providing the media through the terrestrial network to the wireless sites.

Although not described in detail above, it will be recognized that the system of the present invention provides error recovery, quality control, content security, digital rights management and billing functions. The content security, digital rights management and billing functions can employ the terrestrial network. Additionally, an edge receiver can record live content for supplemental use or time delay to accommodate different time zones and for time shifting. In this case, the recorded content is reported back to the content provider responsible for the live broadcast and the recorded content can be included in a program guide provided to the mobile stations.

It will be recognized that although exemplary embodiments have been described in connection with a particular number of content providers, content gateways, satellite gateways, satellites and wireless sites, the present invention is not limited to the particular number described. Thus, for example, it will be recognized that there can be more than two wireless sites, and in some cases hundreds of thousands of wireless sites spread across a large geographic area.

Although the algorithms described above including those with reference to the foregoing flow charts have been described separately, it should be understood that any two or more of the algorithms disclosed herein can be combined in any combination. Any of the methods, algorithms, implementations, or procedures described herein can include machine-readable instructions for execution by: (a) a processor, (b) a controller, and/or (c) any other suitable processing device. Any algorithm, software, or method disclosed herein can be embodied in software stored on a non-transitory tangible medium such as, for example, a flash memory, a CD-ROM, a floppy disk, a hard drive, a digital versatile disk (DVD), or other memory devices, but persons of ordinary skill in the art will readily appreciate that the entire algorithm and/or parts thereof could alternatively be executed by a device other than a controller and/or embodied in firmware or dedicated hardware in a well-known manner (e.g., it may be implemented by an application specific integrated circuit (ASIC), a programmable logic device (PLD), a field programmable logic device (FPLD), discrete logic,). Also, some or all of the machine-readable instructions represented in any flowchart depicted herein can be implemented manually as opposed to automatically by a controller, processor, or similar computing device or machine. Further, although specific algorithms are described with reference to flowcharts depicted herein, persons of ordinary skill in the art will readily appreciate that many other methods of implementing the example machine readable instructions may alternatively be used. For example, the order of execution of the blocks may be changed, and/or some of the blocks described may be changed, eliminated, or combined.

It should be noted that the algorithms illustrated and discussed herein as having various modules which perform particular functions and interact with one another. It should be understood that these modules are merely segregated based on their function for the sake of description and represent computer hardware and/or executable software code which is stored on a computer-readable medium for execution on appropriate computing hardware. The various functions of the different modules and units can be combined or segregated as hardware and/or software stored on a non-transitory computer-readable medium as above as modules in any manner, and can be used separately or in combination.

While particular implementations and applications of the present disclosure have been illustrated and described, it is to be understood that the present disclosure is not limited to the precise construction and compositions disclosed herein and that various modifications, changes, and variations can be apparent from the foregoing descriptions without departing from the spirit and scope of an invention as defined in the appended claims.

What is claimed is:

1. A method comprising:
receiving, by a plurality of wireless sites connected to a terrestrial network, a substantially similar set of media that includes a plurality of individual media independent of a local user request for any of the plurality of individual media in the set of media, wherein each of the wireless sites includes a satellite antenna and satellite receiver via which the set of media is received from a broadcast transmission from a satellite;
storing, by each of the wireless sites, the set of media, wherein each of the wireless sites stores the set of media in a local edge proxy server of the wireless site;
receiving, by one of the plurality of the wireless sites, one or more requests for media from one or more mobile stations;
accessing, by the one of the plurality of wireless sites, the requested media from the set of media stored in the local edge proxy server;
receiving, by one of the plurality of the wireless sites, one or more requests for retransmission of said media from said one or more mobile stations;
determining, by one of the plurality of the wireless sites, if a first of said one or more retransmission requests is identical to a prior retransmission request; and
if said first retransmission request is identical to said prior retransmission request, determining whether said prior retransmission request has been fulfilled.

2. The method of claim 1, wherein if said first retransmission request is not identical to said prior retransmission request, requesting retransmission of at least a portion of the received set of media via the terrestrial network.

3. The method of claim 1, wherein if said prior retransmission request has not been fulfilled, requesting retransmission of at least a portion of the received set of media via the terrestrial network.

4. The method of claim 2, wherein said requesting of retransmission is performed using Backhaul Messaging Protocol (BMP).

5. The method of claim 1, wherein if said prior retransmission request has not been fulfilled, determining whether the one of the plurality of the wireless sites has waited more than a time interval.

6. The method of claim 5, wherein if the one of the plurality of the wireless sites has waited more than a time interval, requesting retransmission of at least a portion of the received set of media via the terrestrial network.

7. An apparatus comprising:
a satellite antenna;
a satellite receiver coupled to the satellite antenna; and
an enhanced edge proxy server coupled to the satellite receiver and to a wireless node, wherein the enhanced edge proxy server includes a processor and memory, the memory storing a set of media, which includes a plurality of individual media, received via the satellite antenna and the satellite receiver, wherein the enhanced edge proxy server
stores the set of media independent of a local user request for any of the plurality of individual media in the set of media
provides a live media stream from the set of media to a mobile station, said providing performed using Evolved Multimedia Broadcast Multicast Service Long-Term Evolution (eMBMS LTE),
wherein the enhanced edge proxy server is located at a wireless site of the wireless node.

8. The apparatus of claim 7, further wherein said enhanced edge proxy server provides said live media stream using an M1 interface.

9. The apparatus of claim 7, further wherein said enhanced edge proxy server comprises an eMBMS Gateway (MBMS GW).

10. The apparatus of claim 9, further wherein said enhanced edge proxy server comprises a Broadcast Multicast Service Center (BM-SC).

11. The apparatus of claim 8, further wherein
said enhanced edge proxy server comprises an MBMS GW; and
said enhanced edge proxy server provides said live media stream to the mobile station via an Evolved Node B (eNodeB) and said MBMS GW,
said eNodeB interfacing to the MBMS GW via the M1 interface.

12. A system to provide one or more sets of media to a plurality of mobile stations, said system comprising a plurality of wireless sites connected to a terrestrial network;
each of said plurality of wireless sites including a satellite antenna and a satellite receiver via which the one or more sets of media is received from a broadcast transmission from a satellite,
each of said plurality of wireless sites serving a corresponding area and comprising an enhanced edge proxy server with an associated storage capacity, wherein each of said plurality of wireless sites stores the one or more sets of media in the corresponding enhanced edge proxy server,
wherein each associated storage capacity depends on at least one of
a size of the area, and
a projected demand,
served by the corresponding wireless site; and
further wherein said system comprises a first wireless site,
said first wireless site comprising a first enhanced edge proxy server, and
said first enhanced edge proxy server storing one or more of the one or more sets of media.

13. The system of claim 12, further wherein said system further comprises a second wireless site;
said second wireless site comprising a second enhanced edge proxy server;
said storage capacity associated with said first enhanced edge proxy server differing from said storage capacity associated with said second enhanced edge proxy server.

14. The system of claim 12, further wherein said one or more sets of media stored by said first enhanced edge proxy server depends on at least one of
a size of the corresponding area served by the first wireless site,
a location of the corresponding area served by the first wireless site,
a context of the corresponding area served by the first wireless site, and
one or more users of one or more of the plurality of mobile stations located within the corresponding area served by the first wireless site.

15. The system of claim 12, wherein said first enhanced edge proxy server serves one of an LTE picocell or an LTE femtocell.
